(19) United States
(12) Patent Application Publication
(10) Pub. No.: US 2019/0016209 A1
(43) Pub. Date: Jan. 17, 2019

(54) AIR DUCT APPARATUS

(71) Applicant: Wesley Langnecker, The Villages, FL (US)

(72) Inventor: Wesley Langnecker, The Villages, FL (US)

(21) Appl. No.: 16/034,287

(22) Filed: Jul. 12, 2018

Related U.S. Application Data
(60) Provisional application No. 62/531,662, filed on Jul. 12, 2017.

(51) Int. Cl. B60K 11/06

(52) U.S. Cl. CPC B60K 11/06; B60Y 2200/86

(57) ABSTRACT

An air duct apparatus includes a bendable piece of material having at least three flat segments and at least two tabs. The lower segment points in a downward direction to facilitate air flow through the air duct apparatus. The upper segment points in an upward direction to facilitate air flow to the motor compartment. The middle segment is parallel to a portion of a ground surface. One of the at least two tabs is located on a right side of the bendable piece of material and a second of the at least two tabs is located on a left side of the bendable piece of material. The horizontal-one-tab-flat segment and the horizontal-second-tab-flat-segment may be to be coupled to a bottom surface of the vehicle. The air duct apparatus provides a cooling effect to the motor compartment of the vehicle by directing air towards the motor compartment.

### CROSS REFERENCE TO RELATED APPLICATION

The present application is related to and claims priority to U.S. Provisional Patent Application No. 62/531,662 filed Jul. 12, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of ventilation devices and more specifically relates to an air duct.

### 2. Description of Related Art

Many individuals use golf carts. A golf cart is a small vehicle designed originally to carry two golfers and their golf clubs around a golf course or on desert trails with less effort than walking. Golf carts come in a wide range of formats and are more generally used to convey small numbers of passengers short distances at speeds less than 15 mph. Golf carts originally were electrically powered, but in time gasoline-powered variants have occurred. Golf Carts that are running at high speeds for long periods of time tend to build up too much heat in the motor compartment creating a vapor lock situation, causing the cart to backfire. A suitable solution is desired.

U.S. Pat. No. 3,606,444 to Howard M. Allenbaugh relates to air scoop means for automotive vehicles. The described air scoop means for automotive vehicles includes a snap-retention air scoop means operatively associated with either the ventilating system, or induction of air to service the engine of an automotive vehicle, or both.

### BRIEF SUMMARY OF THE INVENTION

In view of the foregoing disadvantages inherent in the known ventilation device art, the present disclosure provides a novel air duct apparatus. The general purpose of the present disclosure, which will be described subsequently in greater detail, is to provide a device to cool a carburetor of a vehicle, in particular a golf cart.

An air duct apparatus is disclosed herein. The air duct apparatus includes a bendable piece of material having at least three flat segments and at least two tabs. The at least three flat segments include an upper segment, a lower segment, and a middle segment. The middle segment is positioned between the lower segment and the upper segment. The lower segment points in a downward direction to facilitate air flow through the air duct apparatus. The upper segment points in an upward direction to facilitate air flow to the motor compartment. The middle segment is parallel to a portion of a ground surface.

The at least three flat segments are not coplanar. The at least three flat segments are elongate in shape. One of the at least two tabs is located on a right side of the bendable piece of material. A second of the at least two tabs is located on a left side of the bendable piece of material. The horizontal-one-tab-flat-segment and the horizontal-second-tab-flat-segment are configured to be coupled to a bottom surface of the vehicle. The air duct apparatus is configured to provide a cooling effect to the motor compartment of the vehicle by directing air towards the motor compartment. The present invention keeps a temperature of a motor down and reduces backfire due to a vapor lock type problem.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an air duct apparatus, constructed and operative according to the teachings of the present disclosure.

FIG. 1 is a perspective view of the air duct apparatus of FIG. 1, according to an embodiment of the present disclosure.

FIG. 2 is a perspective view of the air duct apparatus of FIG. 1, according to an embodiment of the present disclosure.

FIG. 3 is a perspective view of the air duct apparatus of FIG. 1, according to an embodiment of the present disclosure.

FIG. 4 is a perspective view of the air duct apparatus of FIG. 1, according to an embodiment of the present disclosure.

FIG. 5 is a perspective view of the air duct apparatus during an ‘in-use’ condition, according to an embodiment of the disclosure.

The various embodiments of the present invention will hereinafter be described in conjunction with the appended drawings, wherein like designations denote like elements.

### DETAILED DESCRIPTION

As discussed above, embodiments of the present disclosure relate to a ventilation device and more particularly to an air duct apparatus as used to improve the air duct.

Generally, the present invention provides an air duct to more efficiently cool a golf cart carburetor. As designed, it fastens to the bottom of the cart frame and catches air while in motion. This prevents overheating and a vapor lock problem that can cause backfire. The present invention comprises a specially designed piece of aluminum to guide air flow directly towards the motor.

The device may include a 3-inch flat plane with a 2-inch flap pointing down in the front, and a 2-inch flap pointing upward in the rear. It may be approximately 25-inches wide with 1-inch tabs on either end to mount. It should only take away approximately 1½ inch of ground clearance. The plate will be attached underneath the engine, on the frame work. The lower part will be front facing. The tab that points up will be facing the motor. This will force the air up and through the motor well. The exact specifications may vary.

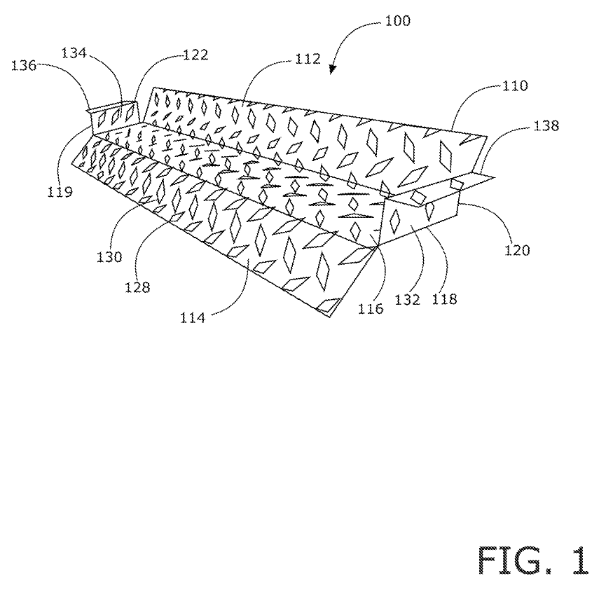

Referring now more specifically to the drawings by numerals of reference, there is shown in FIGS. 1-5, various views of an air duct apparatus 100. FIG. 1 shows a perspective view of the air duct apparatus 100 of FIG. 1, according to an embodiment of the present disclosure. As illustrated, the air duct apparatus 100 for cooling a motor compartment of a vehicle 20 includes a bendable piece of material creating a plate-like structure which may be attached underneath an engine on framework. Typically, there are two frame rails underneath the engine, with a cross member connecting them. The device may be mounted by bolt, rivets or other fasteners on the cross member.

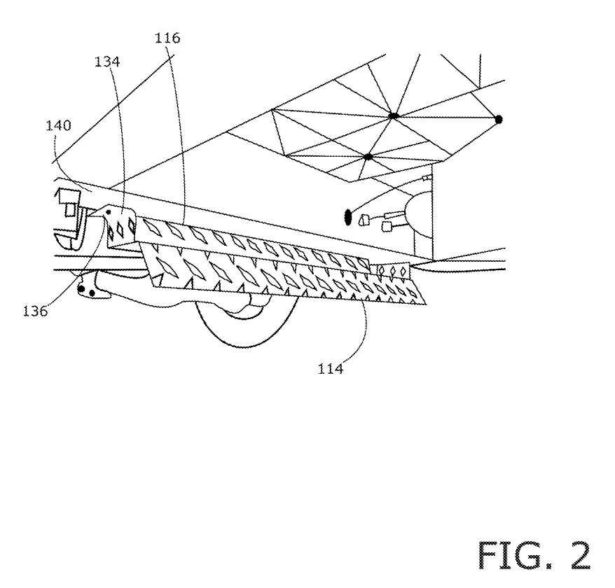

FIG. 2 shows a perspective view of the air duct apparatus 100 of FIG. 1, according to an embodiment of the present disclosure. In a preferred embodiment, the bendable piece of material may have at least three flat segments and at least two tabs. The at least three flat segments include an upper segment 112, a lower segment 114, and a middle segment 116. The middle segment 116 is positioned between the lower segment 114 and the upper segment 112. The lower segment 114 points in a downward direction to facilitate air flow through the air duct apparatus 100. The upper segment 112 points in an upward direction to facilitate air flow to the motor compartment. The middle segment 116 is parallel to a portion of a ground surface. The at least three flat segments are not coplanar. The at least three flat segments are elongate in shape. One of the at least two tabs 118 is located on a right side 120 of the bendable piece of material. A second of the at least two tabs 119 is located on a left side 122 of the bendable piece of material. The air duct apparatus 100 is configured to provide a cooling effect to the motor compartment of the vehicle 20.

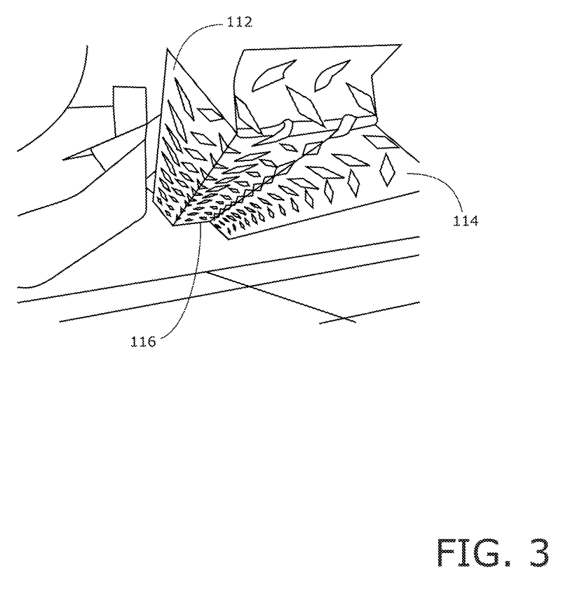

FIG. 3 shows a perspective view of the air duct apparatus 100 of FIG. 1, according to an embodiment of the present disclosure. As above, the air duct apparatus 100 may include the bendable piece of material, at least three flat segments, and at least two tabs. The bendable piece of material may comprise aluminum or other suitable material. The bendable piece of material has a plurality of substantially diamond-shaped FIGS. 124 disposed about a surface area 126 of the bendable piece of material. The bendable piece of material is one continuous piece of material creating the plate-like structure which may be attached underneath an engine on framework of a vehicle 20 such as a golf cart. The plurality of substantially diamond-shaped FIGS. 124 is disposed about the surface area 126 in an alternating pattern. The alternating pattern is comprised of a first row 128 of the plurality of substantially diamond-shaped FIGS. 124 facing in a first direction and a second row 130 of the plurality of substantially diamond-shaped FIGS. 124 facing in an opposite second direction. The device cools a carburetor and high revving engines.

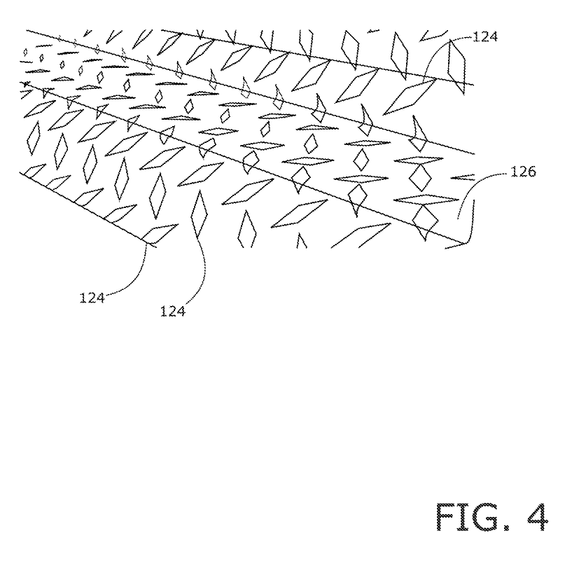

FIG. 4 shows a perspective view of the air duct apparatus 100 of FIG. 1, according to an embodiment of the present disclosure. As above, the air duct apparatus 100 may include at least three flat segments and at least two tabs. The at least three segments are rectangular in shape. At least two of the at least three segments are substantially congruent. The at least two substantially congruent segments are about 2 inches in width. The middle segment 116 is about 3 inches in width. The one tab 118 may comprise two one-tab-flat-segments. The second tab 119 may comprise two second-tab-flat-segments. One of the one-tab-flat-segments is vertical 132 and another of the one-tab-flat-segments is horizontal 138. One of the second-tab-flat-segments is vertical 134 and another of the second-tab-flat-segments is horizontal 136. The horizontal-one-tab-flat-segment is configured to be coupled to a bottom surface 140 of the vehicle 20. The horizontal-second-tab-flat-segment is configured to be coupled to a bottom surface 140 of the vehicle 20.

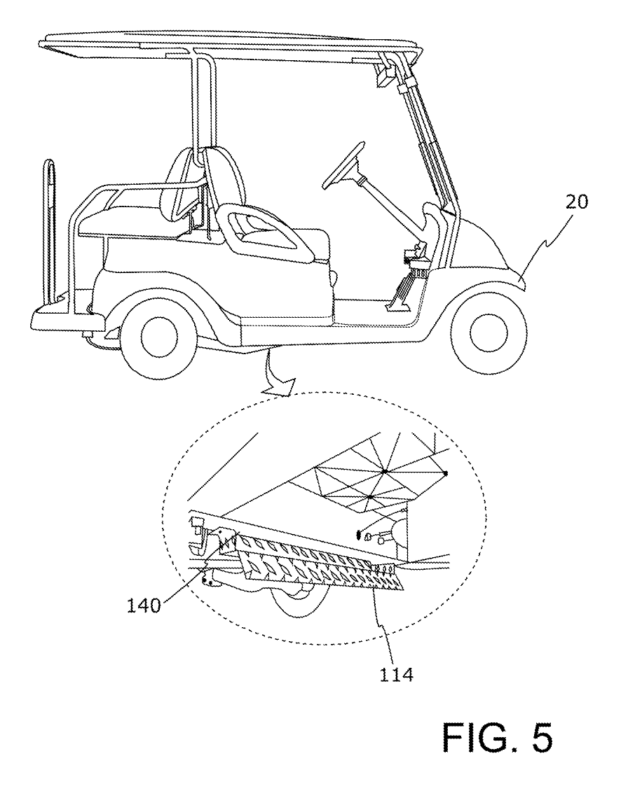

FIG. 5 shows an air duct apparatus 100 during an ‘in-use’ condition, according to an embodiment of the present disclosure. The air duct apparatus 100 when coupled to a vehicle 20, forces air up through a motor roll. The device keeps the engine temperature down to avoid backfire due to a vapor lock type problem. This further allows carts to run at high speeds for longer periods of time while keeping the motor temperature down.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An air duct apparatus for cooling a motor compartment of a vehicle, said air duct apparatus comprising:
a bendable piece of material, said bendable piece of material having at least three flat segments and at least two tabs;
wherein said at least three flat segments include an upper segment, a lower segment, and a middle segment, wherein said middle segment is positioned between said lower segment and said upper segment;
wherein said lower segment points in a downward direction to facilitate air flow through said air duct apparatus;
wherein said upper segment points in an upward direction to facilitate air flow to said motor compartment;
wherein said middle segment is parallel to a portion of a ground surface;
wherein said at least three flat segments are not coplanar;
wherein said at least three flat segments are elongate in shape;
wherein one of said at least two tabs is located on a right side of said bendable piece of material;
wherein a second of said at least two tabs is located on a left side of said bendable piece of material; and
wherein said air duct apparatus is configured to provide a cooling effect to said motor compartment of said vehicle.

2. The air duct apparatus of claim 1, wherein said bendable piece of material is made of aluminum.

3. The air duct apparatus of claim 1, wherein said bendable piece of material has a plurality of substantially diamond-shaped figures disposed about a surface area of said bendable piece of material.

4. The air duct apparatus of claim 1, wherein said bendable piece of material is one continuous piece of material.

5. The air duct apparatus of claim 3, wherein said plurality of substantially diamond-shaped figures is disposed about said surface area in an alternating pattern.

6. The air duct apparatus of claim 5, wherein said alternating pattern is comprised of a first row of said plurality of substantially diamond-shaped figures facing in a first direction and a second row of said plurality of substantially diamond-shaped figures facing in an opposite second direction.

7. The air duct apparatus of claim 1, wherein said at least three segments are rectangular in shape.

8. The air duct apparatus of claim 1, wherein at least two of said at least three segments are substantially congruent.

9. The air duct apparatus of claim 8, wherein said at least two substantially congruent segments are about 2 inches in width.

10. The air duct apparatus of claim 1, wherein said middle segment is about 3 inches in width.

11. The air duct apparatus of claim 1, wherein said one tab comprises two one-tab-flat-segments.

12. The air duct apparatus of claim 11, wherein said second tab comprises two second-tab-flat-segments.

13. The air duct apparatus of claim 12, wherein one of said one-tab-flat-segments is vertical.

14. The air duct apparatus of claim 13, wherein another of said one-tab-flat-segments is horizontal.

15. The air duct apparatus of claim 12, wherein one of said second-tab-flat-segments is vertical.

16. The air duct apparatus of claim 13, wherein another of said second-tab-flat-segments is horizontal.

17. The air duct apparatus of claim 14, wherein said horizontal-one-tab-flat-segment is configured to be coupled to a bottom surface of said vehicle.

18. The air duct apparatus of claim 16, wherein said horizontal-second-tab-flat-segment is configured to be coupled to a bottom surface of said vehicle.

19. An air duct apparatus for cooling a motor compartment of a vehicle, said air duct apparatus comprising:
a bendable piece of material, said bendable piece of material having at least three flat segments and at least two tabs;
wherein said at least three flat segments include an upper segment, a lower segment, and a middle segment, wherein said middle segment is positioned between said lower segment and said upper segment;
wherein said lower segment points in a downward direction to facilitate air flow through said air duct apparatus;
wherein said upper segment points in an upward direction to facilitate air flow to said motor compartment;
wherein said middle segment is parallel to a portion of a ground surface;
wherein said at least three flat segments are not coplanar;
wherein said at least three flat segments are elongate in shape;
wherein one of said at least two tabs is located on a right side of said bendable piece of material;
wherein a second of said at least two tabs is located on a left side of said bendable piece of material;
wherein said air duct apparatus is configured to provide a cooling effect to said motor compartment of said vehicle;
wherein said bendable piece of material is made of aluminum;
wherein said bendable piece of material has a plurality of substantially diamond-shaped figures disposed about a surface area of said bendable piece of material;
wherein said bendable piece of material is one continuous piece of material;
wherein said plurality of substantially diamond-shaped figures is disposed about said surface area in an alternating pattern;
wherein said alternating pattern is comprised of a first row of said plurality of substantially diamond-shaped figures facing in a first direction and a second row of said plurality of substantially diamond-shaped figures facing in an opposite second direction;
wherein said at least three segments are rectangular in shape;
wherein at least two of said at least three segments are substantially congruent;
wherein said at least two substantially congruent segments are about 2 inches in width;
wherein said middle segment is about 3 inches in width;
wherein said one tab comprises two one-tab-flat-segments;
wherein said second tab comprises two second-tab-flat-segments;
wherein one of said one-tab-flat-segments is vertical;
wherein another of said one-tab-flat-segments is horizontal;
wherein one of said second-tab-flat-segments is vertical;
wherein another of said second-tab-flat-segments is horizontal;
wherein said horizontal-one-tab-flat-segment is configured to be coupled to a bottom surface of said vehicle; and
wherein said horizontal-second-tab-flat-segment is configured to be coupled to a bottom surface of said vehicle.
